(19) United States
(12) Patent Application Publication
(10) Pub. No.: US 2007/0054662 A1
(43) Pub. Date: Mar. 8, 2007

(54) Reconfigurable radio system with error recognition and treatment

(75) Inventors: Markus Dillinger, Munich (DE); Rainer Falk, Poing (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT WITTELSBACHERPLATZ 2, GERMANY (DE)

(21) Appl. No.: 10/574,500

(22) PCT Filed: Sep. 30, 2004
(86) PCT No.: PCT/EP04/52381

§ 371 Date: Apr. 3, 2006

(51) Int. Cl. H04Q 7/20

(52) U.S. Cl. 455/423; 455/418

(57) ABSTRACT

Error configuration information is stored in a radiocommunication device in addition to normal operation configuration information. The error configuration information is activated in the event of an error to establish a communication connection to a computer for treating errors.

### CROSS REFERENCE TO RELATED APPLICATIONS

This application is based on and hereby claims priority to German Application No. 10346006.3 filed on Oct. 2, 2003, the contents of which are hereby incorporated by reference.

### BACKGROUND OF THE INVENTION

1. Field of the Invention

The invention relates to a radio system, a radiocommunication device as well as to a method for modifying a radio interface.

2. Description of the Related Art

In view of the large number of different radio interfaces used worldwide, reconfigurable radio systems (Software Defined Radio Systems (SDR Systems)) will assume an increasingly important role in future mobile radio communication. A reconfigurable radio system allows a dynamic and flexible adaptation of radio characteristics and thus enables the available radio communication resources to be used in an efficient manner.

It is important for a radiocommunication device of a reconfigurable radio system to function correctly in order to guarantee the stability and availability of the radio system. An incorrectly configured radiocommunication device can interfere with and thereby adversely affect other users or devices, which means other radiocommunication devices, or even an entire radio cell or other radio systems. For example, in the case in which no suitable protective measures are taken, an incorrectly configured radiocommunication device can disturb air traffic communication and thus pose a considerable danger of accidents.

Regardless of the errors described above, an incorrect configuration of a radiocommunication device can further lead to the radiocommunication device not being able to be used in the way expected by the user.

A typical administration architecture of a reconfigurable radio system is described in K. Moessner, S. Gultchev, R. Tafazolli, Software Defined Radio Reconfiguration Management, International Symposium on Personal, Indoor and Mobile Radio Communication (PIMRC'01), Volume 1, San Diego, Calif., USA, pages 91 to 95, 30 Sep. to 03 Oct. 2001 or in WO 02/43422. Furthermore a telecommunication network with a plurality of terminals and a central server is described in EP 1 170 967 A1, with the server featuring an area for configuration of the terminals, a unit for transmission to the terminal of software and/or data, which is suitable for the recorded hardware of the terminals, and a device for configuration of the software on the relevant terminal A transmit device is provided in the terminals for sending a configuration code to the server, with the hardware configuration and the software configuration of the terminal being identified by this configuration code.

Furthermore a mobile radio station is described in WO 97/16938, which is set up so that software implemented in the mobile radio station can be at least partly modified. The current versions of the software implemented on the mobile stations are stored in a software database connected to the mobile radio communication network. A download unit checks the software installed on the mobile stations by referencing the software database and where necessary loads the required software into the mobile stations.

Furthermore a mobile radio communication system is described in EP 1 164 810 A1, in which a corresponding recorded announcement is transmitted to the mobile radiocommunication device if an authentication error occurs within the framework of authenticating a mobile radio terminal in a mobile radio communication network. Furthermore a call is sent from the mobile radio communication network to a customer service center to reprogram the mobile radio terminal.

A network device which is in a debug mode is disclosed in US 2002/0083156. The network device knows the names of the last images which functioned correctly and the associated configuration file which are both stored on a server computer. The network device requests the transmission of the correctly functioning images and the associated configuration file from the server computer, for example by the TFTP (Trivial File Transfer Protocol) communication protocol.

In order to avoid the disturbances described above in a radio communication system as a result of a faulty radiocommunication device, provision has been made, for a reconfigurable radiocommunication device, as described in TRUST Deliverable D4.3, Report on Assessment of Novel Solutions on System Aspects of Reconfigurable Terminals and Recommendations for Standardisations, Section 4.2.1, Initial mode switching architecture, pages 169 to 176 and Section 6.2.1, Security in SDR terminals, pages 336 to 343, December 2001, for an incorrectly configured radio communication device to be detected and deactivated. A radiocommunication device can detect an incorrect configuration either itself by a built-in monitoring function or the incorrect configuration is signaled to it by a monitoring computer provided in the radio system (for example by an explicit message that an error has occurred or implicitly by the absence of a confirmation message that the radiocommunication device is operating correctly).

A configuration in this context is especially taken to mean characteristics of the radiocommunication device such as radio characteristics, for example the operating frequency, an operating frequency band, the transmit power and/or the type of modulation used, but can also mean other components such as communication protocols used or encoding devices or decoding devices used (for encoding/decoding voice data, picture data, video data).

If an incorrectly configured radiocommunication device has been detected corrective measures are taken to rectify the problem. As described above it has been proposed in TRUST Deliverable D4.3 that the radiocommunication device involved be deactivated, either for a certain period of time or permanently. Naturally no communication using the radiocommunication device is possible any longer in the event of such a deactivation. The result is that the radiocommunication device involved can no longer be used. This case can also occur if the configuration of the radiocommunication device is so faulty that no communication is possible any longer.

If the error is so serious that it is not sufficient to deactivate the radiocommunication device for a certain period, the incorrect configuration must be rectified in another way. This can for example require that the radiocommunication device is sent back to the manufacturer or is taken to a workshop where the error which has occurred can then be rectified. Such a measure is naturally associated with inconveniences for the user since the radiocommunication device cannot be used for a certain period. This would result in lower customer satisfaction levels and high service costs.

A Java specification of a profile of a mobile communication device is described in Java specification request JSR-118 Mobile Information Device Profile, Version 2.0, Public Draft, 2002, available in the Internet on 20 Jul. 2003. Furthermore the so-called Mobile Execution Environment Functional Description (MExE) is described in 3GPP TS 23.057 V.5.0.0, Mobile Execution Environment (MExE) Functional Description, March 2002, available in the Internet on 20 Jul. 2003. 3GPP TS 33.102 V5.0.0, 3G Security Architecture, June 2002, available on the Internet describes a standardized security architecture in a third-generation mobile radio system.

### SUMMARY OF THE INVENTION

The problem underlying the invention is thus that of providing method for treatment of errors in a reconfigurable radio system which offers a simpler and more user-friendly solution than that provided by the related art. The solution is intended to make it possible not to have to deactivate incorrectly configured radiocommunication devices, which can then only be put back into correct operation using complex and expensive measures. The problem is solved by the radio system, the radiocommunication device as also by the method for reconfiguration of a radio interface in accordance with the invention.

A radio system features at least one radiocommunication device. The radiocommunication device has a reconfigurable radio interface as well as a first memory in which information about a normal operating configuration is stored and a second memory in which error configuration information is stored. It should be pointed out in this context that the first memory and the second memory can be a shared memory and that the two items of configuration information can be merely stored in a different areas of the memory.

Furthermore a control unit is provided in the radiocommunication device for configuring the reconfigurable radio interface. The radio system also features an error detection device which is set up to detect an error of the reconfigurable radio interface. An error treatment device also provided in the radio system is set up so that it is able to use error configuration information to provide error treatment so that the reconfigurable radio interface can be configured in accordance with the error configuration information.

The error detection device can be provided both in a processor of the radio communication network and also integrated into the radiocommunication device itself. The error treatment device is preferably implemented in a processor of the radio communication network.

Thus the radiocommunication device in accordance with one aspect of the invention features a reconfigurable radio interface as well as a first memory in which configuration information relating to normal operation is stored and a second memory in which configuration information relating to errors is stored. Furthermore a control unit is provided for configuring the reconfigurable radio interface. Furthermore an error detection device is provided in the radiocommunication device which is set up to detect an error in the reconfigurable radio interface. The control unit for configuring the reconfigurable radio interface is set up so that, on occurrence of an error, it can use the error configuration information to establish a communication connection to a processor providing error treatment.

In a method for modifying a reconfigurable radio interface an error in the reconfigurable radio interface is detected and the reconfigurable radio interface is configured using error configuration information stored in a radiocommunication device.

Clearly the invention can be seen as enabling the faulty radiocommunication device no longer simply to have to be switched off as in the related art if an error in a reconfigurable radio interface is detected, but as storing error configuration information in the radiocommunication device which is used as part of error treatment as a basis for the new configuration of the reconfigurable radio interface. The error configuration information thus clearly represents a fall back configuration of the radiocommunication device.

Thus in accordance with the invention the problem of how corrective measures for an incorrectly configured radio terminal, meaning an incorrect configuration of the radiocommunication device can be taken if the radio communication has been deactivated as a result of a detected malfunction of the radio terminal or if the radiocommunication device has been configured so incorrectly that no communication is possible any longer. Furthermore the invention deals with the problem in which, on a configurable radiocommunication device regardless of a possible incorrect configuration, the radio interface is to make possible an emergency call, which means that an emergency communication connection should be able to be set up in any event.

Thus the invention clearly creates a radiocommunication device for wireless communication with a communication network, with the radio characteristics of the radiocommunication device being able to be reconfigured, in which case furthermore in the radio system, preferably in the radiocommunication device, a monitoring function for detecting an incorrect configuration of the radiocommunication device is provided and in which case the radiocommunication device further contains a control unit which in the event of an incorrect configuration detected can initiate predetermined corrective measures preferably using the error configuration information stored in the radiocommunication device.

The radio system, as well as the radiocommunication device are preferably set up as a mobile radio system or a mobile radiocommunication device respectively.

Furthermore an emergency call device is provided in the radiocommunication device which is set up so that an emergency call can be established with the radio communication network of the radio system even in the event of an error.

Radio characteristics of the reconfigurable radio interface are preferably predetermined in the configuration information for normal operation as well as in the configuration information for errors.

In accordance with an embodiment of the invention there is provision, in the error configuration information as well as in the normal operation configuration information, for at least a part of the radio characteristics of the reconfigurable radio interface, preferably the reconfigurable mobile radio interface listed below to be included:

a transmit power of the (mobile) radiocommunication device;

a modulation method used within the context of (mobile) radio communication;

one or more frequency bands to be used within the context of (mobile) radio communication and also

the communication protocol to be used within the context of (mobile) radio communication.

The radiocommunication device is preferably set up as a radio telephone, especially preferably as a mobile radio telephone, alternatively as a radio module, preferably as a mobile radio module.

In accordance with another embodiment of the invention there is provision for the error treatment device to be integrated into a separate electronic chip, separated from other devices used to operate the mobile radiocommunication device.

Thus the radio communication network of the radio system, or more precisely a processor in the radio communication network, clearly contains a repair function, the error treatment device and the radiocommunication device contains information for an error configuration, the error configuration information, which allows communication with this repair function. If an incorrect configuration is detected by a monitoring function (the error detection device) for detecting an incorrect configuration in the radio communication network, alternatively in the radio communication device, the control unit, instead of activating the current incorrect configuration which is described by the normal operation configuration information, activates the error configuration, meaning the error configuration information. The error configuration is used to allow communication between the radiocommunication device and the repair function which is preferably located in the radio communication network, with a configuration being determined as part of the communication between radiocommunication device and the repair function which the control unit activates instead of the error configuration (meaning the error configuration information).

The radio communication network can be a network of a cellular mobile radio communication network, a public communication network for example based on the Internet or a non-public communication network, for example an Intranet, an in-house communication network as well as a Personal Area Network.

Preferably the error configuration information stored in the radiocommunication device is not modified at all or is only modified using specific predetermined safety precautions which are different from those for reconfiguration of the reconfigurable mobile radio interface in normal operation.

As described above, in accordance with one embodiment of the invention a specific hardware component is also contained in the radiocommunication device, preferably a separate electronic chip which is only used when an error occurs. For example there is provision to use a usual GSM chipset for actual mobile radio communication as well as a specific additional chip in which the functionality of the error detection device is implemented and if necessary the error configuration information is stored.

The steps provided within the context of error treatment and repair of the configuration of the radio interface which are executed by the control unit or the error detection device and the repair function provided in the radio communication network and the information used within the context of this processing are exchanged between the radiocommunication device and the error treatment device or the repair function respectively, can be predetermined depending on the embodiment of the desired method. They can especially feature one all more of the following steps:

a determination of the identity of the radiocommunication device involved;

a determination of the identity of the user (subscriber) of the radiocommunication device involved or of the mobile communication device itself;

a determination of the incorrect configuration; this means that in normal operation configuration information is transmitted to the repair function, in other words to the error treatment device if this is provided in the radio communication network of the radio system; this information can either be loaded directly from the radiocommunication device involved or alternatively from a server in the communication network on which information about the incorrect normal operation configuration information is stored (in accordance with an embodiment of the invention this server is the reconfiguration manager); The normal operation configuration information features one or more of the following items of information: Details of the manufacturer, Type, Version and/or serial number of the radiocommunication device, a designation and version of the installed software as well as further configuration parameters of the radiocommunication device which can be predetermined;

a determination of the reason and which led to the activation of the error configuration information;

an evaluation of log data with the log data being loaded from the radiocommunication device or from a server computer provided in the radio communication network;

loading a diagnosis program onto the radiocommunication device concerned and starting and executing the diagnosis using the diagnosis program;

loading a repair program which replaces the incorrect configuration by an operable configuration by new configuration information onto the radiocommunication device involved and starting the repair program,

deleting, replacing or updating the program modules stored on the radiocommunication device concerned and also

setting configuration parameters required accordingly which form new updated normal operation configuration information.

A display unit also provided in the radiocommunication device can be used to display to the user of the radiocommunication device and thereby inform him that an error has occurred and has been detected. Preferably the user is informed about the progress of the repair measures, again using the display unit of the radiocommunication device where this is present.

In accordance with another embodiment of the invention, there is preferably additional provision for the described measures to be initiated even if no error in the radiocommunication device has been detected. The initiation can be undertaken by the user of the radiocommunication device himself or by a processor, generally an entity correspondingly set up in the communication network, for example in the case in which there is even only a suspicion of a malfunction. In this way it is possible to avoid greater damage by the actual occurrence of a malfunction.

The error configuration information and the associated repair function are supplemented in accordance with one embodiment of the invention by further measures which are described below:

In accordance with one embodiment of invention there is provision for defining the error configuration information in a suitable manner. The error configuration information is on the one hand to be implemented simply and with little effort in the radiocommunication device. On the other hand the effort should also be kept as low as possible on the radio communication network side. To guarantee this it is advantageous to use a radio system which is already available such as GSM, but for the error configuration information in the radiocommunication device only to implement those functions of radio system absolutely necessary. This keeps the expenditure low on the terminal side, meaning in the radiocommunication device and furthermore the existing mobile radio infrastructure, in general terms the radio infrastructure, can be advantageously employed.

Whereas in Europe an almost full-coverage GSM mobile radio communication network is present, this is not guaranteed in all regions of the world.

In accordance with an embodiment of the invention it is also advantageous for this reason to be able to modify the error configuration information oneself. This then allows a mobile radio communication network which is more widespread in another region of the world and thereby is more suitable there than GSM to be used, for example the DAMPS (Digital Advanced Mobile Phone Service) or IS-95 system. The modification of the error configuration information is preferably undertaken using specific safety precautions. In particular there is provision for the error configuration not to be able to be modified within the framework of the normal reconfiguration, meaning in the same way as the normal operation configuration information stored in the first memory. The result of this is that a normal operation configuration for regular operation, meaning normal operation, is provided which can be adapted flexibly and dynamically to user requirements, locally available radio services, current utilization of the communication network and currently used radio system services etc.

In other words the normal operation configuration information can be modified in a simple manner, the error configuration information only if the correspondingly provided increased security requirements are fulfilled.

The error configuration information is thus provided for the case in which an error has occurred in configuration for normal operation. The error configuration information can, if at all, only be modified using particular security precautions, preferably cryptographic security precautions. In this way it is possible to design the control over the configuration for normal operation relatively openly since when an error occurs, if for example in the context of configuration of the radio interface something goes wrong with the radiocommunication device, by using the error configuration information, a stable, operable configuration of the radiocommunication device can be provided again.

If the error configuration information can be modified in the second memory, then for a modification of the error configuration information in accordance with one embodiment of the invention, special, preferably cryptographic, security precautions are provided. This means especially that configuration information, as defined and able to be used in ongoing operation, cannot be simply defined as error configuration information and that not every device which can define or modify the normal regular configuration, meaning the normal operation configuration information, can also define or modify the error configuration information.

In particular in the case in which the operator in ongoing operation, meaning in a normal operation of the radiocommunication device, is able to define a configuration himself using software from a number of manufacturers, it is advantageous if the error configuration information can only use such configuration information which has been authorized by the manufacturer of the radiocommunication device himself as error configuration information.

There is however provision in an alternative embodiment of the invention for a service provider to be responsible for the definition of the error configuration information. This can be a specific service provider offering this particular service or the communication service provider offering pre-determinable communication services to his customers (subscribers). In this case only the corresponding service provider can modify error configuration information.

Usual security mechanisms can be used in this context to safeguard access to error configuration information. Thus for example, in accordance with an embodiment of the invention, the authentication of the person wishing to modify the error configuration information for example by using a password or cryptographic security mechanisms for authentication is to be provided using a secret cryptographic key or a public cryptographic key.

Furthermore in accordance with another embodiment of the invention there is provision for securing a communication with the radiocommunication device for example by using a cryptographically secured communication protocol IPsec or SSL/TSL. Furthermore access control can be provided, meaning a check as to whether an accessing communication device is actually authorized to access the error configuration information as well as a protection of the software modules used in order to check their providers and their integrity, for example using a signed code such as described for example in MExE 23.057 or in JSR-118 MIDP 2.0. This method which is known per se is preferably used in accordance with the invention in order to secure or both Access to regular configuration, meaning a normal operation configuration information as well as error configuration information.

In particular there is provision for using the same security mechanisms for securing access to normal operation configuration information as are used for access to error configuration information. Access to the error configuration information for modifying it is however defined in accordance with a correspondingly predetermined security policy to be more restrictive than access to normal operation configuration information for modifying it. This means that other more restrictive policy information (who is authorized) possibly also other cryptographic material with correspondingly higher cryptographic security will be used within the framework of securing the error configuration information than for securing the normal operation configuration information.

Furthermore there is provision in accordance with another embodiment of the invention that the radiocommunication device which has activated the error configuration information and wishes to establish a communication connection to the error treatment device, meaning the repair function in the communication network, signals this fact on establishing the communication connection to the communication network. In this way the communication network is given the opportunity of reacting especially to error configuration information. There is provision for example for initiating specific monitoring functions which go beyond the normal monitoring of the radiocommunication device in order to possibly detect a radiocommunication device which is still faulty. Furthermore the usable services can be restricted. This means that only such services are able to be used in a corresponding error case for which such error configuration information is provided. These services which can be used in the event of an error can be defined by the radio communication network used. It is likewise possible for entries to be stored in the relevant user profile of the user of the radiocommunication device which specify the usable services in the event of an error.

In a third-generation mobile radio system the user profile is preferably stored in a computer of the Home Subscriber System (HSS).

If, when the radio communication connection is established, it is signaled that the radiocommunication device is in an error configuration and would like to call a repair function using the error configuration information, the operator of the communication network has the opportunity of permitting the network access depending on his specifications if no successful use the authentication is possible or has been undertaken or if no authorization to use regular communication services exists.

This method corresponds to support for an emergency call, meaning for setting up an emergency call communication connection which is also possible without the user having been authenticated and checking of the authorization of the user as regards permission to access the relevant service (or authorization for an emergency call is always provided).

In this case the radio communication device is set up in accordance with 3GPP TS 33.102 V5.0.0, 3G Security Architecture, Paragraph 6.4.9, in which case the behavior for an emergency call is described especially in 3GPP TS 33.102 V5.0.0, 3G Security Architecture, Paragraph 6.4.9.2, which states the circumstances under which a corresponding security procedure may be dispensed with for an emergency call. The radiocommunication device is set up in accordance with an embodiment of the invention as described there.

In the radiocommunication device security parameters for the event of an error can be present which will be used in the event of an error configuration in order to detect a trustworthy repair function and/or to secure communication with it. Such security parameters are especially identification data (IP address of a server which provides a trustworthy repair function, a DNS name of such a server or an E. 164 number of such a server) and cryptographic material (a secret key, a private key, a public key or a number of certificates). Usual methods using IPsec or SSL/TLS can be used as security mechanisms for secure communication with the computer program which implements the repair function.

A radiocommunication device uses these security parameters in accordance with an embodiment of the invention to ensure that it is communicating with a trustworthy repair function and that the communication has not been manipulated. Furthermore it is made possible in this way for the repair function to be able to reliably identify the radiocommunication device involved.

In addition, in accordance with another embodiment of the invention, there is provision for the error configuration information to also enable an emergency call to be issued. In this way the ability to always make an emergency call regardless of the current configuration is achieved. This aspect is significant if regulation demands that an emergency call must always be possible regardless of its current configuration for a reconfigurable radiocommunication device.

In summary, in the case in which a fatal error in the configuration of a radiocommunication device, especially a reconfigurable radio interface is detected, the invention means that it is not necessary as with systems of the related art to deactivate radio communication. Instead, in accordance with the invention, a specific error configuration is provided for such an error case and corresponding error configuration information is activated which at least makes it possible to communicate with a repair function. In this way it is possible to determine operable configuration information and activate it in the radiocommunication device, which means reconfiguring the reconfigurable radio interface in accordance with the operable configuration information.

In this way it is possible to design the control over the configuration of the radiocommunication device for regular operation (normal operation) relatively openly since, in the event of an error, if something goes wrong, a stable and functioning radiocommunication device can be obtained again by using the error configuration information.

Regardless of the current configuration of the radiocommunication device it is also possible to issue an emergency call in this case in accordance with one embodiment of the invention. This characteristic is especially of significance if it is demanded by a standard or by the requirements of a regulation authority.

### BRIEF DESCRIPTION OF THE DRAWINGS

These and other objects and advantages of the present invention will become more apparent and more readily appreciated from the following description of an exemplary embodiment, taken in conjunction with the accompanying drawings of which:

FIG. 1 is a block diagram of radio system in accordance with an exemplary embodiment the invention;

FIG. 2 is a block diagram of a radiocommunication device in accordance with the exemplary embodiment of the invention;

FIG. 3 is a flowchart showing the individual steps in accordance with the exemplary embodiment of the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

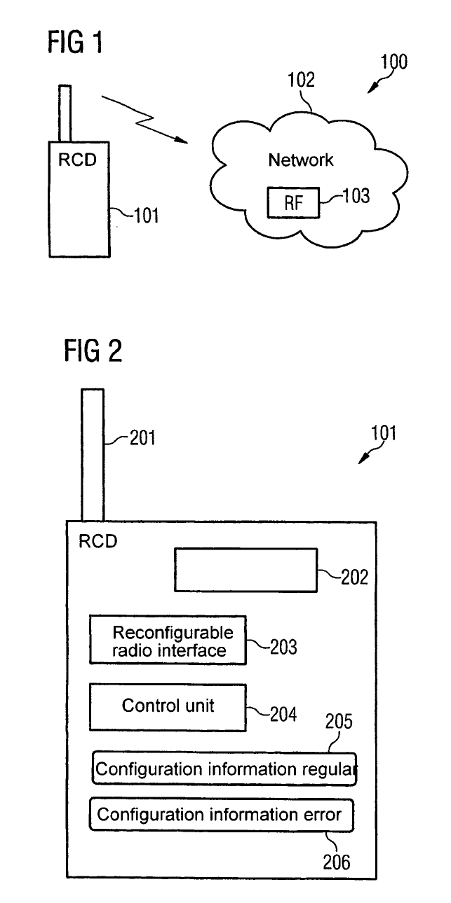

FIG. 1 shows a mobile radio system 100 with a mobile radio terminal 101 as a mobile radiocommunication device, as well as a mobile radio communication network 102 which is set up so that communication in accordance with the GSM Standard is provided. Although FIG. 1 only shows one a mobile radio terminal 101 in order to simplify the diagram, there is provision in the mobile radio system 100 for any number of mobile radio terminals 101. A server computer 103 is contained in the mobile radio communication network 102 in which a repair function described in more detail below is stored and provided in order to handle errors in the mobile radio terminal 101 described in more detail below.

FIG. 2 shows the mobile radio terminal 101 in greater detail. The mobile radio terminal 101 features a mobile radio antenna 201 fitted to its housing as well as a display device 202 and a plurality of operator keys arranged in a key pad (not shown) for entry of digits and or/predetermined special characters as well as for starting (setting up) and ending (clearing down) a communication connection.

Furthermore the mobile radio terminal 101 features a reconfigurable mobile radio interface 203 as well as a control unit 204 designed as a microprocessor and a first memory 205 in which regular configuration information, referred to below as normal operation configuration information is stored, and a second memory 206 in which error configuration information is stored. The reconfigurable mobile radio interface 203 has the reconfigurable radio characteristics of the mobile radio terminal 101 in accordance with this exemplary embodiment

the operating frequency used or the operating frequencies or the frequency band or the frequency bands used respectively for communication,

the transmit power used for communication,

the modulation method used within the framework of communication as well as

the communication protocols used within the framework of communication

In normal operation the control unit 204 configures the reconfigurable mobile radio interface 103 in accordance with the radio characteristics or radio parameters specified in the normal operation configuration information 205.

If an error is detected by an error detection device which can be implemented in the mobile radio terminal 101 or in a processor in the mobile radio communication network 102 also partly in the mobile radio terminal 101 and partly in the mobile radio communication network 102, the control unit 204, on an appropriate signal from the error detection device, activates the error configuration information, as is described in greater detail below.

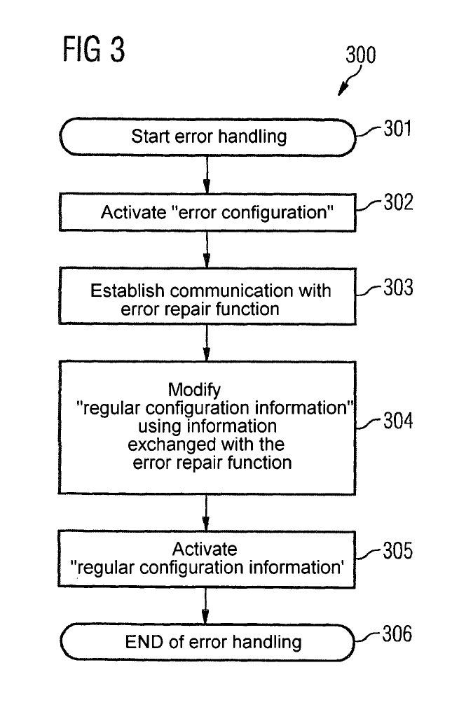

If the control unit and 204 receives a corresponding error signal from the error detection device, the method shown in FIG. 3 in a flowchart 300 is executed. The method shown in the flowchart 300 begins with a start step 301. The error treatment begins after an error has been detected in the mobile radio terminal 101 itself, or it has been signaled by the mobile radio network 102 to the mobile radio terminal 101 that an error is present, or if error treatment has been triggered in some other way.

Error treatment starts with the activation of the error configuration information. This means that the configuration of the reconfigurable mobile radio interface 203 is no longer defined by the normal operation configuration information 205 which has been recognized as being in error, but by the error configuration information 206 (step 302).

Using the error configuration information, a communications connection is set up by the mobile radio terminal 101 with the error repair function, as provided by the repair function processor 103 which is located in the mobile radio communication network 102 (step 303). If the communication connection between the mobile radio terminal 101 and the repair function processor 103 is established, the mobile radio terminal 101 and the error repair processor exchange information which is required for treating the error which has occurred and has been determined.

The information especially contains the normal operation configuration information (especially the software modules to be used, the relevant version as well as other predetermined configuration parameters) but can further contain information for identifying the mobile radio terminal 101 (information about the manufacturer, the type of mobile radio terminal and also its serial number and its user (in the case of a cellular mobile radio systems such as GSM or UTMS, its IMSI (International Mobile Subscriber Identity)).

This information can be each transferred directly from the mobile radio terminal 101 to the error repair function processor 103. It is however also possible in an alternative embodiment for there to be a processor (node) in the mobile radio communication network 102 which also contains information about the normal operation configuration information, the processor also being referred to as a reconfiguration manager.

In this case the mobile radio terminal 101 preferably transmits information which allows the error repair processor to access this data. An example is the address of the reconfiguration manager which contains the normal operation configuration information as well as identification information, for example the International Mobile Equipment Identifier (IMEI) information or the IMSI for a cellular mobile radio communication network or an IEEE MAC address or the IP address or the URL (Uniform Resource Locator) or the URI (Uniform Resource Identifier) of the reconfiguration manager as well as of the mobile radio terminal 101 involved, by which identification information the error repair function processor 103 can request the normal operation configuration information from the specified reconfiguration manager.

The mobile radio terminal 101 modifies the normal operation configuration information using the information exchanged with the error repair function processor (step 304). This information can especially feature instructions from the error treatment function for setting or modifying configuration parameters in accordance with the new information transferred or the additional information transferred for the normal operation configuration information as well as for deleting, updating or adding software modules as well as new or updated software modules.

After completion of the modification the now updated normal operation configuration information (step 304) is activated and the mobile radio terminal 101 is configured in accordance with the now modified normal operation configuration information (step 305). This means that at this point in time the error configuration information is no longer activated.

This ends the error treatment (step 306) and the mobile radio terminal 101 is again operated in its normal operating mode using the updated or modified normal operation configuration information and can establish a normal communication connection.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A radio system with at least one radiocommunication device, comprising:
a reconfigurable radio interface;
a first memory in which normal operation configuration information is stored;
a second memory in which error configuration information is stored;
a control unit configuring the reconfigurable radio interface;
an error detection device detecting an error of the reconfigurable radio interface; and
an error treatment device using the error configuration information to provide error treatment so that the reconfigurable radio interface is reconfigured.

16. A radio system in accordance with claim 15, wherein said radio system is a mobile radio system.

17. A radio system in accordance with claim 16, wherein the error treatment device is integrated into an electronic chip separate from said control unit.

18. A radio system in accordance with claim 17, wherein the radiocommunication device includes an emergency call device that sets up an emergency call even if the radiocommunication device has a fault.

19. A radio system in accordance with claim 15, wherein said reconfigurable radio interface has radio characteristics predetermined in at least one of the normal operation configuration information and the error configuration information.

20. A radio system in accordance with claim 15, wherein at least one of the normal operation configuration information and the error configuration information contain at least some of the following radio characteristics of the reconfigurable radio interface:
a transmit power of the radiocommunication device,
a modulation method to be used within a framework of radio communication,
at least one frequency to be used within the framework of radio communication,
at least one frequency band to be used within the framework of radio communication, and
a communication protocol to be used within the framework of radio communication.

21. A radiocommunication device associated with a processor providing error treatment, comprising:
a reconfigurable radio interface;
a first memory in which normal operation configuration information is stored;
a second memory, in which error configuration information is stored; and
a control unit configuring said reconfigurable radio interface on occurrence of an error to set up a communication connection to the processor providing error treatment using the error configuration information.

22. A radiocommunication device in accordance with claim 21, wherein said radiocommunication device is a mobile radiocommunication device.

23. A radiocommunication device in accordance with claim 22, wherein said radiocommunication device is a mobile radio telephone.

24. A radiocommunication device in accordance with claim 22, wherein said radiocommunication device is a mobile radio module.

25. A radiocommunication device in accordance with claim 21, further comprising an emergency call device that sets up an error-free emergency call communication connection even upon an error.

26. A radiocommunication device in accordance with one of the claims 21, wherein said reconfigurable radio interface has radio characteristics given in at least one of the normal configuration information and the error configuration information.

27. A radiocommunication device in accordance with claim 26, wherein at least one of the normal operation configuration information and the error configuration information contain at least some of the following radio characteristics of the reconfigurable radio interface:
a transmit power of the radiocommunication device,
a modulation method to be used within a framework of radio communication,
at least one frequency to be used within the framework of radio communication,
at least one frequency band to be used within the framework of radio communication, and
a communication protocol to be used within the framework of radio communication.

28. A method for modifying a reconfigurable radio interface of a radiocommunication device, comprising:
detecting an error of the reconfigurable radio interface of the radiocommunication device;
performing error treatment by a control unit using error configuration information stored in addition to the normal operation configuration information in the radiocommunication device; and
configuring the reconfigurable radio interface in accordance with the configuration information.
